(19) United States
(12) Patent Application Publication
(10) Pub. No.: US 2023/0380338 A1
(43) Pub. Date: Nov. 30, 2023

(54) Garden Rake Assembly

(71) Applicant: Leon Franks, Soap Lake, WA (US)

(72) Inventor: Leon Franks, Soap Lake, WA (US)

(21) Appl. No.: 17/827,740

(22) Filed: May 29, 2022

(51) Int. Cl. A01D 7/02; A01D 7/06

(52) U.S. Cl. CPC A01D 7/02; A01D 7/06

(57) ABSTRACT

A garden rake assembly for breaking soil in a garden includes a rake that has a head and a handle that is attached to the head. The rake has a plurality of tines that each extends away from the head. Each of the tines lies on a horizontal plane when the rake is positioned in a standing position having the handle angling upwardly from the head. Each of the tines is oriented to angle downwardly from the head when the handle is urged downwardly thereby facilitating the tines to engage soil for breaking the soil when the handle is pulled by a user.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to rake devices and more particularly pertains to a new rake device for breaking soil in a garden. The device includes a head, a handle attached to the head and a plurality of tines extending away from the head. The tines lie on a horizontal plane when the rake is in a standing position. In this way the tines angle downwardly when the handle is pulled thereby facilitating the tines to break soil when the rake is drawn along the soil.

(2) Description of Related Art Including Information Disclosed Under 37 CFR 1.97 and 1.98

The prior art relates to rake devices including a rake that has tines and a pair of cutting blades integrated into a head. The prior art discloses a garden hoe that includes a stand that is pivotally coupled to the garden hoe for standing the garden hoe. The prior art discloses a garden rake which has a grip that is pivotally disposed on a handle of the rake. The prior art discloses a garden rake that has cutting edges on opposing ends of a head of the garden rake.

### BRIEF SUMMARY OF THE INVENTION

An embodiment of the disclosure meets the needs presented above by generally comprising a rake that has a head and a handle that is attached to the head. The rake has a plurality of tines that each extends away from the head. Each of the tines lies on a horizontal plane when the rake is positioned in a standing position having the handle angling upwardly from the head. Each of the tines is oriented to angle downwardly from the head when the handle is urged downwardly thereby facilitating the tines to engage soil for breaking the soil when the handle is pulled by a user. The prior art discloses a variety of ornamental designs for garden rakes that each include downwardly pointed tines.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a back perspective view of a garden rake assembly according to an embodiment of the disclosure.

FIG. 2 is a back view of an embodiment of the disclosure.

FIG. 3 is a right side view of an embodiment of the disclosure.

FIG. 4 is a perspective in-use view of an embodiment of the disclosure.

### DETAILED DESCRIPTION OF THE INVENTION

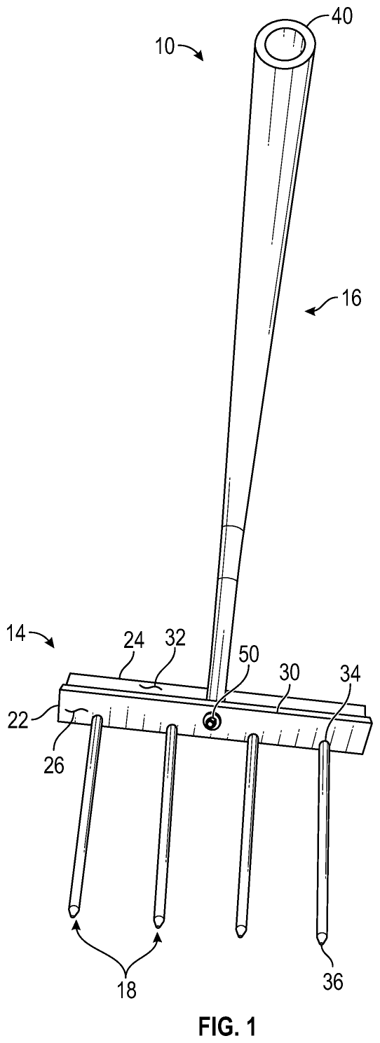

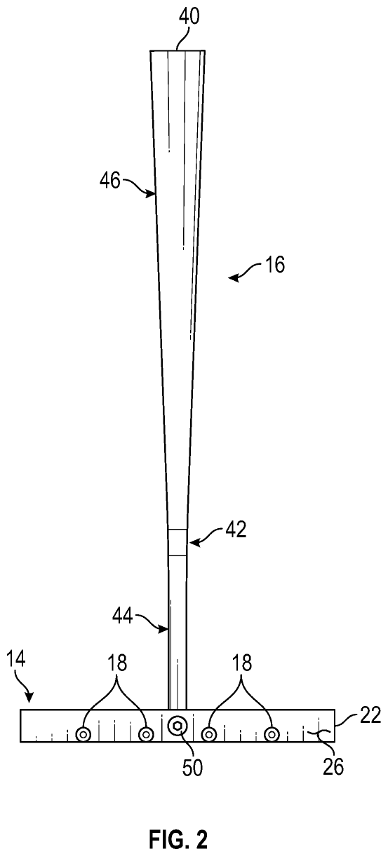

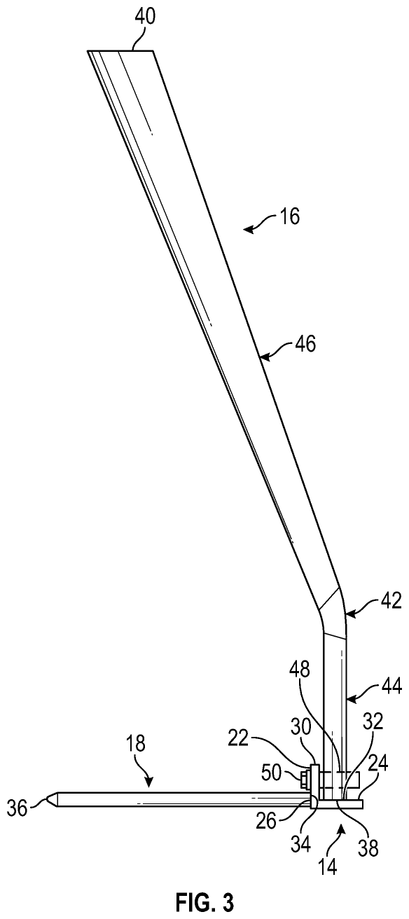

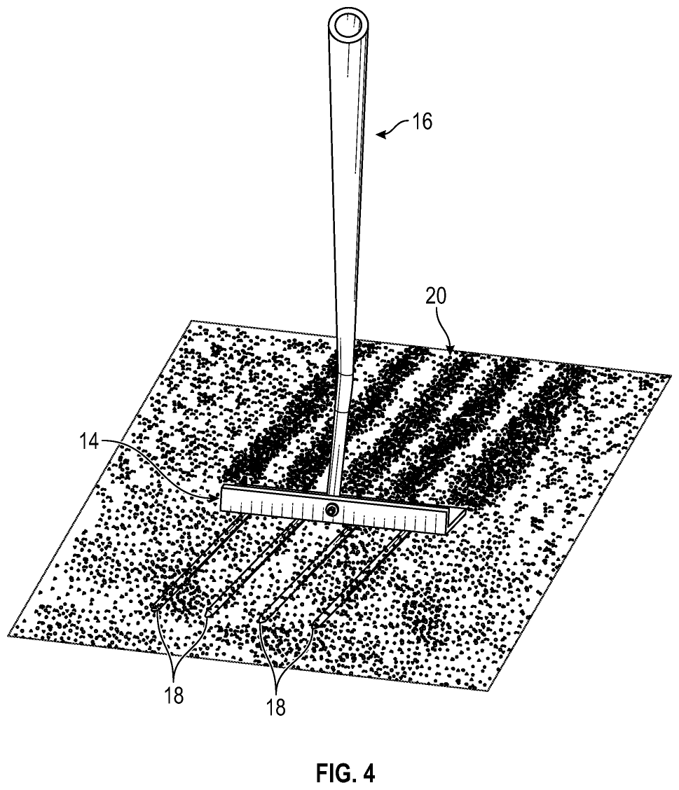

With reference now to the drawings, and in particular to FIGS. 1 through 6 thereof, a new rake device embodying the principles and concepts of an embodiment of the disclosure and generally designated by the reference numeral 10 will be described.

As best illustrated in FIGS. 1 through 6, the garden rake assembly 10 generally comprises a rake 12 that has a head 14, a handle 16 that is attached to the head 14 and a plurality of tines 18 each extending away from the head 14. Each of the tines 18 lies on a horizontal plane when the rake 12 is positioned in a standing position having the handle 16 angling upwardly from the head 14. Each of the tines 18 is oriented to angle downwardly from the head 14 when the handle 16 is urged downwardly thereby facilitating the tines 18 to engage soil 20 for breaking the soil 20 when the handle 16 is pulled by a user. In this way the soil 20 can be broken without using a downward chopping motion as is required when employing a garden hoe or a traditional garden rake.

The head 14 has a first panel 22 forming an angle with a second panel 24, and the first panel 22 has a rearwardly facing surface 26, a forwardly facing surface 28 and a top edge 30. The second panel 24 has an upwardly facing surface 32 and the second panel 24 lies on a horizontal plane having the first panel 22 extending upwardly from the second panel 24 when the rake 12 is in the standing position. Each of the tines 18 has a first end 34 and a second end 36, and the first end 34 of each of the tines 18 is attached to the rearwardly facing surface 26 of the first panel 22. Each of the tines 18 is aligned with an intersection between the first panel 22 and the second panel 24. Additionally, the second end 36 of each of the tines 18 tapers to a point thereby facilitating the second end 36 of each of the tines 18 to penetrate the soil 20.

The handle 16 has a primary end 38 and a secondary end 40, and the handle 16 is elongated between the primary end 38 and the secondary end 40. The handle 16 has a bend 42 positioned between the primary end 38 and the secondary end 40 to define a first section 44 of the handle 16 forming an angle with a second section 46. The bend 42 is positioned closer to the primary end 38 than the secondary end 40; the primary end 38 is associated with the first section 44 and the secondary end 40 is associated with the second section 46. The handle 16 has a hole 48 extending laterally through the first section 44 of the handle 16 and the hole 48 is spaced from the primary end 38. A fastener 50 is provided which extends through the first panel 22 and which extends through the hole 48 in the first section 44 of the handle 16 for attaching the handle 16 to the head 14. The fastener 50 may be a bolt of other type of releasable, mechanical fastener 50.

In use, the second section 46 of the handle 16 is gripped and the second section 46 of the handle 16 is pulled thereby tilting each of the tines 18 to angle downwardly. In this way the tines 18 can break the soil 20 by dragging the tines 18 through the soil 20 while the handle 16 is pulled. Thus, the soil 20 can be broken without the use of a downward, chopping motion as is common with traditional gardening tools. Furthermore, the broken soil 20 does not have to be scooped or pushed into place as is common with garden hoes. In this way the rake 12 improves the efficiency of breaking soil 20 in a garden.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A garden rake assembly having an angled handle for breaking up soil in garden, said assembly comprising:
a rake having a head and a handle being attached to said head, said rake having a plurality of tines each extending away from said head, each of said tines lying on a horizontal plane when said rake is positioned in a standing position having said handle angling upwardly from said head, each of said tines being oriented to angle downwardly from said head when said handle is urged downwardly thereby facilitating said tines to engage soil for breaking the soil when said handle is pulled by a user.

2. The assembly according to claim 1, wherein said head has a first panel forming an angle with a second panel, said first panel having a rearwardly facing surface, a forwardly facing surface and a top edge, said second panel having an upwardly facing surface, said second panel lying on a horizontal plane having said first panel extending upwardly from said second panel when said rake is in said standing position.

3. The assembly according to claim 2, wherein each of said tines has a first end and a second end, said first end of each of said tines being attached to said rearwardly facing surface of said first panel, each of said tines being aligned with an intersection between said first panel and said second panel, said second end of each of said tines tapering to a point thereby facilitating said second end of each of said tines to penetrate the soil.

4. The assembly according to claim 2, wherein said handle has a primary end and a secondary end, said handle being elongated between said primary end and said secondary end, said handle having a bend being positioned between said primary end and said secondary end to define a first section of said handle forming an angle with a second section, said bend being positioned closer to said primary end than said secondary end, said primary end being associated with said first section, said secondary end being associated with said second section.

5. The assembly according to claim 3, wherein said handle has a hole extending laterally through said first section of said handle, said hole being spaced from said primary end.

6. The assembly according to claim 5, further comprising a fastener extending through said first panel and extending through said hole in said first section of said handle for attaching said handle to said head.

7. A garden rake assembly having an angled handle for breaking up soil in garden, said assembly comprising:
a rake having a head and a handle being attached to said head, said rake having a plurality of tines each extending away from said head, each of said tines lying on a horizontal plane when said rake is positioned in a standing position having said handle angling upwardly from said head, said each of said tines being oriented to angle downwardly from said head when said handle is urged downwardly thereby facilitating said tines to engage soil for breaking the soil when said handle is pulled by a user, said head having a first panel forming an angle with a second panel, said first panel having a rearwardly facing surface, a forwardly facing surface and a top edge, said second panel having an upwardly facing surface, said second panel lying on a horizontal plane having said first panel extending upwardly from said second panel when said rake is in said standing position, each of said tines having a first end and a second end, said first end of each of said tines being attached to said rearwardly facing surface of said first panel, each of said tines being aligned with an intersection between said first panel and said second panel, said second end of each of said tines tapering to a point thereby facilitating said second end of each of said tines to penetrate the soil, said handle having a primary end and a secondary end, said handle being elongated between said primary end and said secondary end, said handle having a bend being positioned between said primary end and said secondary end to define a first section of said handle forming an angle with a second section, said bend being positioned closer to said primary end than said secondary end, said primary end being associated with said first section, said secondary end being associated with said second section, said handle having a hole extending laterally through said first section of said handle, said hole being spaced from said primary end; and
a fastener extending through said first panel and extending through said hole in said first section of said handle for attaching said handle to said head.
